(19) United States
(12) Patent Application Publication
(10) Pub. No.: US 2009/0257356 A1
(43) Pub. Date: Oct. 15, 2009

(54) Enhanced channel quality indication reports

(75) Inventors: Frank Frederiksen, Klarup (DK); Troels E. Kolding, Klarup (DK); Istvan Z. Kovacs, Aalborg (DK); Klaus I. Pedersen, Aalborg (DK)

Correspondence Address: HARRINGTON & SMITH, PC, 4 RESEARCH DRIVE, Suite 202, SHELTON, CT, 06484-6212, US

(73) Assignee: Nokia Siemens Networks Oy

(21) Appl. No.: 12/082,658

(22) Filed: Apr. 11, 2008

(51) Int. Cl. H04L 12/26; H04Q 7/00

(52) U.S. Cl. 370/252; 370/241; 370/329

(57) ABSTRACT

A method includes making measurements of a received channel, and transmitting a channel quality report that includes at least one resource block-specific report indicative of a value of a channel quality metric over a bandwidth x, and that further includes an additional report indicative of the value of the channel quality metric over a bandwidth y, where y is greater than x. The channel quality metric may be a signal to interference plus noise ratio (SINR), and the additional channel quality report may be indicative of a difference between a mean value of the SINR of physical resource blocks found by a user equipment to exceed a reporting threshold and a mean value of the SINR over the measurement bandwidth y.

### TECHNICAL FIELD

The exemplary and non-limiting embodiments of this invention relate generally to wireless communication systems, methods, devices and computer programs and, more specifically, relate to signaling of channel measurement-related reports between a mobile device or node and a network device or node.

### BACKGROUND

Various abbreviations that appear in the specification and/or in the drawing figures are defined as follows:
3GPP third generation partnership project
UTRAN universal terrestrial radio access network
EUTRAN evolved UTRAN (LTE)
LTE long term evolution
Node B base station
eNB EUTRAN Node B (evolved Node B)
UE user equipment
UL uplink (UE towards eNB)
DL downlink (eNB towards UE)
EPC evolved packet core
MME mobility management entity
S-GW serving gateway
MM mobility management
HO handover
C-RNTI cell radio network temporary identifier
PDU protocol data unit
PRB physical resource block
PHY physical
RB radio bearer
RLC radio link control
RRC radio resource control
RRM radio resource management
MAC medium access control
PDCP packet data convergence protocol
O&M operations and maintenance
SDU service data unit
BW bandwidth
CQI channel quality indication
FDMA frequency division multiple access
OFDMA orthogonal frequency division multiple access
PS packet scheduler
FDPS frequency domain packet scheduler
LA link adapter
SC-FDMA single carrier, frequency division multiple access
MIMO multiple-input, multiple-output
VoIP voice over internet protocol
HARQ hybrid automatic repeat request
SINR signal to interference plus noise ratio
PUCCH physical uplink control channel
PUSCH physical uplink shared channel
PMI preceding matrix index

A proposed communication system known as evolved UTRAN (E-UTRAN, also referred to as UTRAN-LTE or as E-UTRA) is currently under development within the 3GPP. The current working assumption is that the DL access technique will be OFDMA, and the UL access technique will be SC-FDMA.

One specification of interest to these and other issues related to the invention is 3GPP TS 36.300, V8.3.0 (2007-12), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), which is incorporated by reference herein in its entirety.

FIG. 1 reproduces FIG. 4 of 3GPP TS 36.300, and shows the overall architecture of the E-UTRAN system. The E-UTRAN system includes eNBs, providing the E-UTRA user plane (PDCP/RLC/MAC/PHY) and control plane (RRC) protocol terminations towards the UE. The eNBs are interconnected with each other by means of an X2 interface. The eNBs are also connected by means of an Si interface to an EPC, more specifically to a MME (Mobility Management Entity) by means of a S1-MME interface and to a Serving Gateway (S-GW) by means of a S1-U interface. The S1 interface supports a many-to-many relation between MMEs/Serving Gateways and eNBs.

The eNB hosts the following functions:

functions for Radio Resource Management: Radio Bearer Control, Radio Admission Control, Connection Mobility Control, Dynamic allocation of resources to UEs in both uplink and downlink (scheduling);

IP header compression and encryption of user data stream;

selection of a MME at UE attachment;

routing of User Plane data towards Serving Gateway;

scheduling and transmission of paging messages (originated from the MME);

scheduling and transmission of broadcast information (originated from the MME or O&M); and

measurement and measurement reporting configuration for mobility and scheduling.

Of particular interest herein is, for example, subclause 5.2.3, “Physical uplink control channel”, which states that the PUCCH is mapped to a control channel resource in the uplink. A control channel resource is defined by a code and two resource blocks, consecutive in time, with hopping at the slot boundary. Depending on presence or absence of uplink timing synchronization, the uplink physical control signaling can differ. In the case of time synchronization being present, the outband control signaling consists of CQI; ACK/NAK and Scheduling Request (SR).

The CQI informs the scheduler about the current channel conditions as seen by the UE. If MIMO transmission is used, the CQI includes necessary MIMO-related feedback. The HARQ feedback in response to downlink data transmission consists of a single ACK/NAK bit per HARQ process. The PUCCH resources for SR and CQI reporting are assigned and can be revoked through RRC signaling. An SR is not necessarily assigned to UEs acquiring synchronization through the RACH (i.e. synchronized UEs may or may not have a dedicated SR channel). PUCCH resources for SR and CQI are lost when the UE is no longer synchronized.

Also of interest is subclause 11.5 “CQI reporting for Scheduling”, where it is said that the time and frequency resources used by the UE to report CQI are under the control of the eNB. CQI reporting can be either periodic or aperiodic. A UE can be configured to have both periodic and aperiodic reporting at the same time. In a case where both periodic and aperiodic reporting occurs in the same subframe, only the aperiodic report is transmitted in that subframe.

For efficient support of localized, distributed and MIMO transmissions, E-UTRA supports three types of CQI reporting:

A) wideband type that provides channel quality information of the entire system bandwidth of the cell;

B) multi-band type that provides channel quality information of some subset(s) of the system bandwidth of the cell; and

C) MIMO type. The MIMO schemes for Release 8 of LTE are currently defined in the PHY layer specification found in 3GPP TS 36.213, V8.2.0 (2008-03), 3^{rd} Generation Partnership Project; Technical Specification Group Radio Access Network; Evolved Universal Terrestrial Radio Access (E-UTRA); Physical layer procedures (Release 8). These MIMO schemes use the precoding matrix index (PMI) and Rank information as feedback. Reference can also be made to 3GPP TS 36.211, V8.2.0 (2008-03), 3^{rd} Generation Partnership Project; Technical Specification Group Radio Access Network; Evolved Universal Terrestrial Radio Access (E-UTRA); Physical channels and modulation (Release 8).

Periodic CQI reporting is defined by the following characteristics. When the UE is allocated PUSCH resources in a subframe where a periodic CQI report is configured to be sent, the periodic CQI report is transmitted together with uplink data on the PUSCH. Otherwise, the periodic CQI reports are sent on the PUCCH.

Aperiodic CQI reporting is defined by the following characteristics. The report is scheduled by the eNB via the PDCCH and is transmitted together with uplink data on the PUSCH. When a CQI report is transmitted together with uplink data on the PUSCH, it is multiplexed with the transport block by L1 (i.e., the CQI report is not part of the uplink transport block).

The eNB configures a set of sizes and formats of the reports. The size and format of the report depends on whether it is transmitted over the PUCCH or the PUSCH, and whether it is a periodic or an aperiodic CQI report.

As was noted above, the current working assumption in 3GPP is that the multiple access technique will be OFDMA for the downlink. The use of OFDMA provides an opportunity to perform link adaptation and user multiplexing in the frequency domain. In order to effectively perform link adaptation in the frequency domain it is important that the eNB packet scheduler and link adaptation units have knowledge of the instantaneous channel quality. This is obtained through the signaling of the aforementioned CQI reports from different UEs.

Several approaches for defining the CQI contents (e.g., what is being signaled from the UE to the eNode B) have been discussed in 3GPP. Common to many of these approaches (e.g., single-codeword and multi-codeword MIMO CQI methods) is that the UE indicates its best physical resource blocks (PRBs) out of all available PRBs. Examples of this approach can be referred to as the best-M and the threshold CQI (note that the threshold-based CQI approach is not currently being considered for use in LTE).

In order to achieve a highest possible frequency domain packet scheduling gain, the UE should have flexibility in selecting the best PRBs. That is, ideally there should be no restrictions on which PRBs to select. Several prior 3GPP contributions have focused on providing the CQI reporting in such a way that an indication is provided of which PRBs are recommended for scheduling, followed by an indication of the quality (including MIMO precoding information if applicable) of these good PRBs. However, a problem related to this approach is that the eNode B scheduler will only obtain information on the actual channel quality for the good PRBs, and not information on the expected quality of the remaining PRBs. This type of information on the less-than-best PRBs can be important in certain cases, such as when very high data rate users are present (which potentially may be using many PRBS, possibly even more than the CQI is reported for). As another example, a wideband channel quality estimate may be desirable in order to perform diversity transmission for a user moving at high speed.

Thus far, and as was noted above with respect to subclause 11.5 of 3GPP TS 36.300, V8.3.0 (2007-12), CQI measurement reports have typically been discussed as being wideband measurement reports only, or as being some type of per-PRB report. Similar cases have been considered also for the MIMO preceding information that is coupled to or de-coupled from the CQI reports.

### SUMMARY

The foregoing and other problems are overcome, and other advantages are realized, by the use of the exemplary embodiments of this invention.

In a first aspect thereof the exemplary embodiments of this invention provide a method that includes making measurements of a received channel, and transmitting a channel quality report that comprises at least one resource block-specific report indicative of a value of a channel quality metric over a bandwidth x, and that further comprises an additional report indicative of the value of the channel quality metric over a bandwidth y, where y is greater than x.

In another aspect thereof the exemplary embodiments of this invention provide an apparatus that includes a wireless receiver; a wireless transmitter; a measurement unit configurable to make measurements of a received channel and a reporting unit configurable to prepare and send, via the wireless transmitter, a channel quality report. The channel quality report includes at least one resource block-specific report indicative of a value of a channel quality metric over a bandwidth x, and further includes an additional report indicative of the value of the channel quality metric over a bandwidthy, where y is greater than x.

In another aspect thereof the exemplary embodiments of this invention provide a method that comprises receiving a channel quality report that comprises at least one resource block-specific report indicative of a value of a channel quality metric over a bandwidth x, and that further comprises an additional report indicative of the value of the channel quality metric over a bandwidth y, where y is greater than x; and using one or both reports when scheduling resources for a user equipment.

In a further aspect thereof the exemplary embodiments of this invention provide an apparatus having means for making measurements of a received channel; means for composing a channel quality report that comprises at least one resource block-specific report indicative of a value of a channel quality metric over a bandwidth x, and that further comprises an additional report indicative of the value of the channel quality metric over a bandwidth y, where y is greater than x; and means for transmitting the channel quality report to a wireless network node for use in making resource scheduling decisions. In the apparatus the additional channel quality report may be indicative of a difference between a mean value of a signal to interference plus noise ratio (SINR) of physical resource blocks found to exceed a reporting threshold and a mean value of the SINR over the measurement bandwidth y.

In a still further aspect thereof the exemplary embodiments of this invention provide an apparatus that includes means for receiving a channel quality report from a mobile apparatus, the channel quality report comprising at least one resource block-specific report indicative of a value of a channel quality metric over a bandwidth x, and further comprising an additional report indicative of the value of the channel quality metric over a bandwidth y, where y is greater than x; and means for using one or both reports when scheduling resources for a user equipment. The additional channel quality report may be indicative of a difference between a mean value of a signal to interference plus noise ratio (SINR) of physical resource blocks found by the mobile apparatus to exceed a reporting threshold and a mean value of the SINR over the measurement bandwidth y.

### BRIEF DESCRIPTION OF THE DRAWINGS

In the attached Drawing Figures:

FIG. 1 reproduces FIG. 4 of 3GPP TS 36.300, and shows the overall architecture of the E-UTRAN system.

FIG. 2 shows a simplified block diagram of various electronic devices that are suitable for use in practicing the exemplary embodiments of this invention.

FIG. 3 is a graph that shows a non-limiting example of a frequency selective fading profile that is useful in describing the exemplary embodiments of this invention.

FIG. 4 is a logic flow diagram that illustrates the operation of a method by the user equipment, and a result of execution of computer program instructions, in accordance with the exemplary embodiments of this invention.

FIG. 5 is a logic flow diagram that illustrates the operation of a method by the base station, and a result of execution of computer program instructions, in accordance with the exemplary embodiments of this invention.

### DETAILED DESCRIPTION

In the following description emphasis is placed on the best-M CQI reporting method as it is a common baseline assumption in 3GPP for LTE. However, the exemplary embodiments of this invention are not limited for use with the best-M technique, and may be used also with other types of CQI reporting schemes. Also in the following description the PRB is generally used as an indication for the CQI measurement bandwidth (in 3GPP it has been discussed that the CQI-PRB should equal two physical PRBs). However, another CQI measurement bandwidth metric may also be applied and used with the exemplary embodiments.

Reference with regard to various DL channel bandwidths and the like can be made to 3GPP TR 25.814 V7. 1.0 (2006-09), Technical Report 3rd Generation Partnership Project; Technical Specification Group Radio Access Network; Physical layer aspects for evolved Universal Terrestrial Radio Access (UTRA) (Release 7), incorporated by reference herein in its entirety.

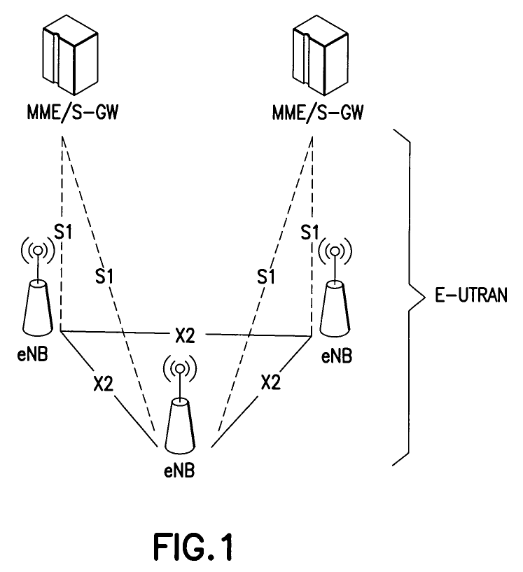

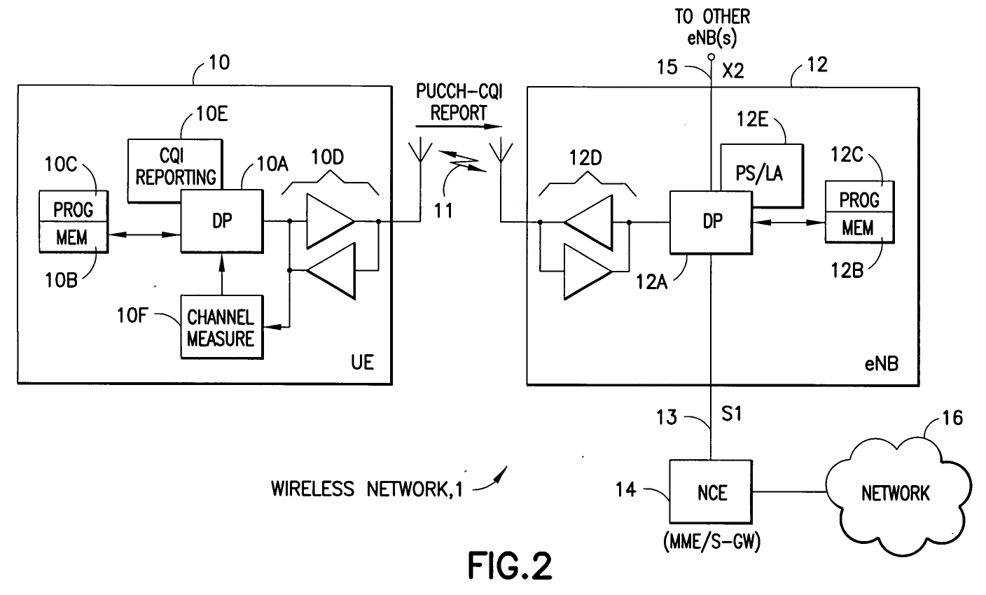

Reference is made to FIG. 2 for illustrating a simplified block diagram of various electronic devices that are suitable for use in practicing the exemplary embodiments of this invention. In FIG. 2 a wireless network 1 is adapted for communication with an apparatus, such as a mobile communication device which may be referred to as a UE 10, via a network access node, such as a Node B (base station), and more specifically an eNB 12. The network 1 may include a network control element (NCE) 14 that may include the MME/S-GW functionality shown in FIG. 1, and which provides connectivity with a network 16, such as a telephone network and/or a data communications network (e.g., the internet). The UE 10 includes a data processor (DP) 10A, a memory (MEM) 10B that stores a program (PROG) 10C, and a suitable radio frequency (RF) transceiver 10D for bidirectional wireless communications with the eNB 12 via at least one antenna. The eNB 12 also includes a DP 12A, a MEM 12B that stores a PROG 12C, and a suitable RF transceiver(s) 12D. The eNB 12 is coupled via a data path 13 to the NCE 14, which may be implemented as the SI interface shown in FIG. 1. At least one of the PROGs 10C and 12C is assumed to include program instructions that, when executed by the associated DP, enable the electronic device to operate in accordance with the exemplary embodiments of this invention, as will be discussed below in greater detail.

That is, the exemplary embodiments of this invention may be implemented at least in part by computer software executable by the DP 10A of the UE 10 and by the DP 12A of the eNB 12, or by hardware, or by a combination of software and hardware.

For the purposes of describing the exemplary embodiments of this invention the UE 10 may be assumed to also include a CQI reporting unit or function 10E and a channel measurement unit or function 10F. The eNB 12 includes a PS/LA unit or function 12E that uses the CQI reports received from the UE 10.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

The exemplary embodiments of this invention beneficially provide combined CQI reporting for per-PRB CQI reporting that reports the quality of the best PRBs, their associated link quality (with a given granularity or accuracy), combined with a quality measure, which denotes or describes the wideband performance or quality relative to the reported quality measure for the best PRBs. Providing the relative wideband quality measure, compared to the best-PRB value, is straightforward because a relative accurate report/value for the best PRBs is already available, and the difference between the best PRB quality and the average quality can be expressed using relatively few bits. This latter fact is true at least for the reason that the eNB 12 needs only a relatively rough estimate of the wideband quality (since the HARQ mechanism compensates for any measurement and reporting inaccuracies).

It should be noted that MIMO precoding reports may be a part of the CQI reports, thus a similar reasoning as outlined above applies for the precoding reports when advanced MIMO transmission is used. Note in this regard that previously the MIMO feedback was referred to as PCI in 3GPP, but is now referred to as the Precoding Matrix Index (PMI). The PMI can be considered basically as the feedback for a code book, i.e., a pointer to recommended transmit antenna weights. The code book definitions are discussed in the above-referenced 3GPP TS 36.211 and 3GPP TS 36.213 documents.

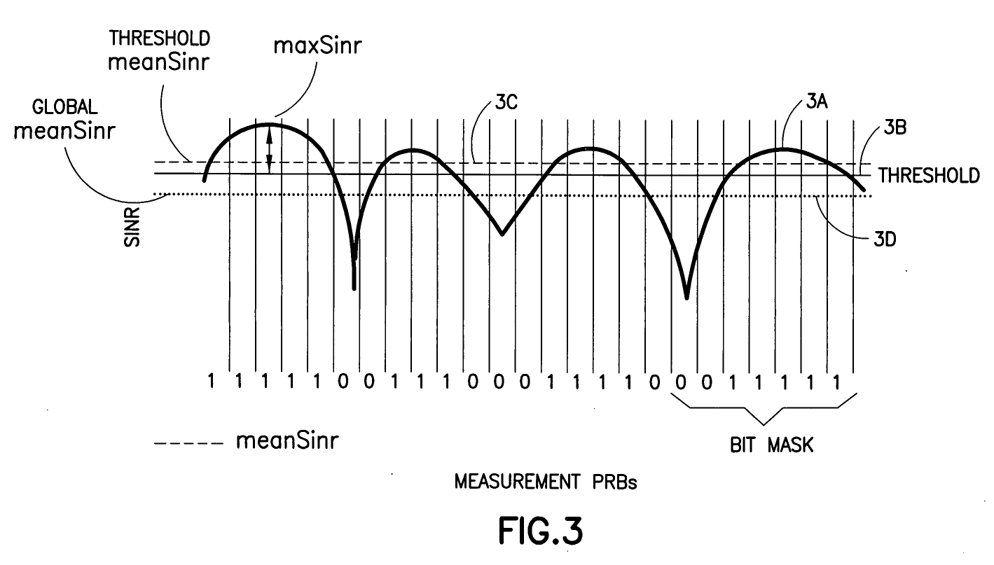

To illustrate the use of the exemplary embodiments, a non-limiting example of a frequency selective fading profile is shown in FIG. 3, where the abscissa represents the measurement PRBs and the ordinate represents SINR values, or whatever equivalent metric is used to represent the channel quality (for example, a performance-related metric such as the supported transport block size may be used). Note that the abscissa may be deemed to represent a total measurement bandwidth of y that encompasses a plurality of PRBs (or some other channel frequency resource units or partitions of interest) each of bandwidth x, where y is (typically) much greater than x.

In FIG. 3 the line designated as 3A represents the varying SINR over the plurality of measurement PRBs, and the line designated as 3B represents a SINR threshold value (relative to the maximum value of the SINR) used to select which SINR values to use for CQI reporting. The dashed line designated as 3C represents the mean or average SINR value of the selected (best) PRBs (indicated by the bit mask shown at the bottom of the Figure). The dotted line designated as 3D represents the global average of the SINR values. From FIG. 3 it can be observed that there is a relatively small difference between the mean SINR for the threshold-selected PRBs and the global mean SINR value. As one may expect there to be a large dynamic range in the threshold-based CQI reporting value (as it represents the path loss in general), it may also be expected that the difference between the threshold-based mean SINR value and the global mean SINR value will be relatively small, such that this value can be transmitted using just a bits (for example, using 2 or 3 bits). This reported value assists the eNB packet scheduler and link adaptation functions 12E when scheduling UEs 10 over a wider bandwidth than is reported by just the CQI. Further, this type of reporting can also be used when the UE 10 needs to employ “coverage transmission”, such as for diversity transmission for a VoIP application (as one non-limiting example).

A number of advantages can be realized by the use of the exemplary embodiments of this invention. For example, the UE 10 is enabled to provide a wideband CQI report in combination with a scheduled CQI report. This ability provides enhanced performance for high data rate and other types of UEs (e.g., those UEs moving a high speed). Based on the foregoing it should be apparent that the exemplary embodiments of this invention provide a method, apparatus and computer program(s) to operate a user equipment to make and transmit an enhanced channel quality report, as well as to operate a base station to receive and utilize the enhanced channel quality report.

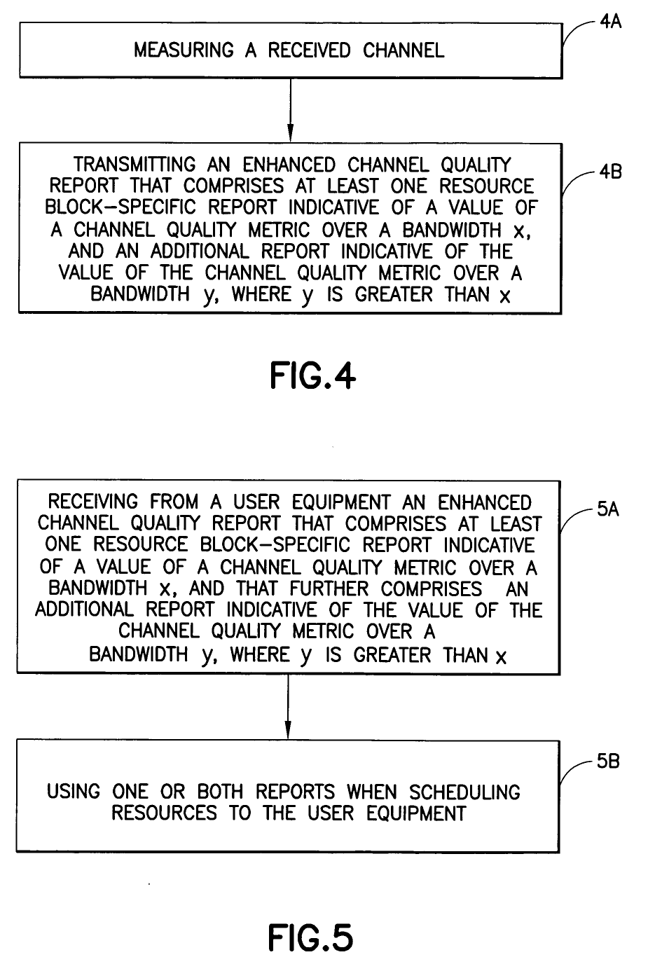

In accordance with a method, and referring to FIG. 4, at Block 4A the user equipment makes measurements of a received channel, and at Block 4B the user equipment transmits an enhanced channel quality report that comprises at least one resource block-specific report indicative of a value of a channel quality metric over a bandwidth x, and that further comprises an additional report indicative of the value of the channel quality metric over a bandwidth y, where y is greater than x.

The method of the preceding paragraph, where the at least one resource block-specific report comprises channel quality indications for M-best physical resource blocks each of bandwidth x measured by the user equipment, and where the additional channel quality report is indicative of channel quality, relative to the reported M-best physical resource blocks, over the bandwidth y.

The method of the preceding paragraphs, where the additional channel quality report is indicative of a difference between the mean value of the reported channel quality indications for the M-best physical resource blocks, and the mean value of a global channel quality over the bandwidth y.

In the method of the preceding paragraphs, where the channel quality metric may be a signal to interference plus noise ratio (SINR) or a performance-related metric, such as a supported transport block size.

The method as in the preceding paragraph, where the additional channel quality report is indicative of a difference between the mean value of the SINR of reported ones of the M-best physical resource blocks, and the mean value of the SINR over the measurement bandwidth y.

In accordance with another method, and referring to FIG. 5, at Block 5A the base station (e.g., the eNB 12) receives from a user equipment an enhanced channel quality report that comprises at least one resource block-specific report indicative of a value of a channel quality metric over a bandwidth x, and that further comprises an additional report indicative of the value of the channel quality metric over a bandwidth y, where y is greater than x; and at Block 5B the base station uses one or both reports when scheduling resources to the user equipment.

The method of the preceding paragraph, where the at least one resource block-specific report comprises channel quality indications for M-best physical resource blocks each of bandwidth x measured by the user equipment, and where the additional channel quality report is indicative of channel quality, relative to the reported M-best physical resource blocks, over the bandwidth y.

The method of the preceding paragraphs, where the additional channel quality report is indicative of a difference between the mean value of the reported channel quality indications for the M-best physical resource blocks, and the mean value of a global channel quality over the bandwidthy.

In the method of the preceding paragraphs, where the channel quality metric may be a signal to interference plus noise ratio (SINR) or a performance-related metric, such as a supported transport block size.

The method as in the preceding paragraph, where the additional channel quality report is indicative of a difference between the mean value the SINR of reported ones of the M-best physical resource blocks, and the mean value of the SINR over the measurement bandwidth y.

The various blocks shown in FIGS. 4 and 5 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is largely a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings.

For example, while described above in the context of using the (difference between) mean values of the SINR of the M-best reported PRBs and the global SINR, the average values might be used instead, or some other mathematical combination of values might be used.

However, any and all modifications will still fall within the scope of the non-limiting and exemplary embodiments of this invention.

For example, while the exemplary embodiments have been described above in the context of the EUTRAN (UTRANLTE) system, it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
making measurements of a received channel; and
transmitting a channel quality report that comprises at least one resource block-specific report indicative of a value of a channel quality metric over a bandwidth x, and that further comprises an additional report indicative of the value of the channel quality metric over a bandwidth y, where y is greater than x.

2. The method of claim 1, where the at least one resource block-specific report comprises channel quality indications for M-best physical resource blocks each of bandwidth x, and where the additional channel quality report is indicative of channel quality, relative to the reported M-best physical resource blocks, over the bandwidth y.

3. The method of claim 1, where the additional channel quality report is indicative of a difference between a mean value of reported channel quality indications for M-best physical resource blocks and a mean value of a channel quality over the bandwidth y.

4. The method of claim 1, where the channel quality metric comprises a signal to interference plus noise ratio (SINR).

5. The method of claim 1, where the channel quality metric comprises a performance-related metric.

6. The method of claim 5, where the performance-related metric is comprised of a supported transport block size.

7. The method of claim 4, where the additional channel quality report is indicative of a difference between a mean value of the SINR of reported ones of the M-best physical resource blocks and the mean value of the SINR over the measurement bandwidth y.

8. The method of claim 4, where the additional channel quality report is indicative of a difference between a mean value of the SINR of those physical resource blocks found to exceed a reporting threshold and the mean value of the SINR over the measurement bandwidth y.

9. The method of claim 1, performed as a result of execution of computer program instructions stored in a memory medium of a user equipment.

10. An apparatus, comprising:
a wireless receiver;
a wireless transmitter;
a measurement unit configurable to make measurements of a received channel; and
a reporting unit configurable to prepare and send, via said wireless transmitter, a channel quality report that comprises at least one resource block-specific report indicative of a value of a channel quality metric over a bandwidth x, and that further comprises an additional report indicative of the value of the channel quality metric over a bandwidthy, where y is greater than x.

11. The apparatus of claim 10, where the at least one resource block-specific report comprises channel quality indications for M-best physical resource blocks each of bandwidth x, and where the additional channel quality report is indicative of channel quality, relative to the reported M-best physical resource blocks, over the bandwidth y.

12. The apparatus of claim 10, where the additional channel quality report is indicative of a difference between a mean value of reported channel quality indications for M-best physical resource blocks and a mean value of a channel quality over the bandwidth y.

13. The apparatus of claim 10, where the channel quality metric comprises a signal to interference plus noise ratio (SINR).

14. The apparatus of claim 10, where the channel quality metric comprises a performance-related metric.

15. The apparatus of claim 14, where the performance-related metric is comprised of a supported transport block size.

16. The apparatus of claim 13, where the additional channel quality report is indicative of a difference between a mean value of the SINR of reported ones of the M-best physical resource blocks and the mean value of the SINR over the measurement bandwidth y.

17. The apparatus of claim 13, where the additional channel quality report is indicative of a difference between a mean value of the SINR of those physical resource blocks found to exceed a reporting threshold and the mean value of the SINR over the measurement bandwidth y.

18. The apparatus of claim 10, embodied as a user equipment.

19. The apparatus of claim 10, embodied at least partially as an integrated circuit.

20. A method comprising:
receiving a channel quality report that comprises at least one resource block-specific report indicative of a value of a channel quality metric over a bandwidth x, and that further comprises an additional report indicative of the value of the channel quality metric over a bandwidth y, where y is greater than x; and
using one or both reports when scheduling resources for a user equipment.

21. The method of claim 20, where the at least one resource block-specific report comprises channel quality indications for M-best physical resource blocks each of bandwidth x, and where the additional channel quality report is indicative of channel quality, relative to the reported M-best physical resource blocks, over the bandwidth y.

22. The method of claim 20, where the additional channel quality report is indicative of a difference between a mean value of reported channel quality indications for M-best physical resource blocks and a mean value of a channel quality over the bandwidth y.

23. The method of claim 20, where the channel quality metric comprises one of a signal to interference plus noise ratio (SINR) and a performance-related metric.

24. The method of claim 20, where the additional channel quality report is indicative of a difference between a mean value of a signal to interference plus noise ratio (SINR) of reported ones of M-best physical resource blocks and a mean value of the SINR over the measurement bandwidth y.

25. The method of claim 20, where the additional channel quality report is indicative of a difference between a mean value of a signal to interference plus noise ratio (SINR) of those physical resource blocks found by a reporting user equipment to exceed a reporting threshold and a mean value of the SINR over the measurement bandwidth y.

26. The method of claim 20, performed as a result of execution of computer program instructions stored in a memory medium of a base station.

27. An apparatus, comprising:
means for making measurements of a received channel;
means for composing a channel quality report that comprises at least one resource block-specific report indicative of a value of a channel quality metric over a bandwidth x, and
that further comprises an additional report indicative of the value of the channel quality metric over a bandwidth y, where y is greater than x; and
means for transmitting the channel quality report to a wireless network node for use in making resource scheduling decisions;
where the additional channel quality report is indicative of a difference between a mean value of a signal to interference plus noise ratio (SINR) of physical resource blocks found to exceed a reporting threshold and a mean value of the SINR over the measurement bandwidth y.

28. An apparatus, comprising:
means for receiving a channel quality report from a mobile apparatus, the channel quality report comprising at least one resource block-specific report indicative of a value of a channel quality metric over a bandwidth x, and further comprising an additional report indicative of the value of the channel quality metric over a bandwidth y, where y is greater than x; and
means for using one or both reports when scheduling resources for a user equipment;
where the additional channel quality report is indicative of a difference between a mean value of a signal to interference plus noise ratio (SINR) of physical resource blocks found by the mobile apparatus to exceed a reporting threshold and a mean value of the SINR over the measurement bandwidth y.
